(19) United States
(12) Patent Application Publication
(10) Pub. No.: US 2010/0194044 A1
(43) Pub. Date: Aug. 5, 2010

(54) Gaming apparatus & method

(76) Inventor: Anthony Eladio Sneek, Dakota (AW)

Correspondence Address: FURGANG & ADWAR, 2 CROSFIELD AVENUE, WEST NYACK, NY, 10994, US

(21) Appl. No.: 12/387,709

(22) Filed: May 6, 2009

Related U.S. Application Data
(60) Provisional application No. 61/126,964, filed on May 8, 2008.

(51) Int. Cl. A63F 3/06; G07C 15/00

(52) U.S. Cl. 273/269; 273/144 A

(57) ABSTRACT

A method of playing a game of chance by a player including the steps of: (a) providing a set of game matrices to each player, each matrix within a set being associated with a particular game in a series of games; (b) assigning a pari-mutual number sequence to each set of game matrices; (c) playing each game within the series of games; (d) allocating a respective number drawn during each game of the series to a respective position within a resulting pari-mutual number sequence; and (e) comparing each assigned pari-mutual number sequence to the resulting pari-mutual number sequence; and (f) identifying at least one assigned pari-mutual number sequence that most closely matches the resulting pari-mutual number sequence.

### FIELD OF THE INVENTION

The field of the invention is game of chance, an apparatus and system therefor.

### BACKGROUND

There are well known games of chance such as bingo, keno, and lotto. Bingo and lotto are frequently run by governments or charities as vehicles for fund raising. Keno is most frequently played in casinos. Each of these games has its own advantages and disadvantages.

In bingo, game cards are flat pieces of cardboard or non-reusable paper which contain twenty-five squares arranged in five vertical and five horizontal rows. Dual dab, or “double-action” cards have two numbers in each square. Each space in the grid contains a number, except for the center square, which is considered filled. The highest number used is 75. The letters ‘B,’ ‘I,’ ‘N,’ ‘G,’ and ‘O’ are preprinted above the five vertical columns, with one letter appearing above each column. The center space is marked “free.” The printed numbers on each card correspond to the following arrangement: I to 15 in the ‘B’ column; 16 to 30 in the ‘I’ column; 31 to 45 in the ‘N’ column; 46 to 60 in the ‘G’ column; and 61 to 75 in the ‘O’ column.

Randomly selected numbers are drawn. The drawn numbers are announced to the assembled players. The players match the called numbers to those appearing on their game cards. Game cards may be preprinted or electronically represented. The first player to fill out or daub a game card of drawn numbers in a predetermined pattern is the winner and calls out the word “Bingo!” which alerts others and informs the caller of the win. The card is first checked for accuracy. A “win” is then officially confirmed and a prize is awarded. Afterwards, a new game may begin.

The card used in each game may have a predetermined pattern. On each turn, a “caller” randomly selects a numbered ball from a container or ball-blower and announces the retrieved number to the players. The ball is then set aside so that it cannot be chosen again. Each player searches his/her card for the called number, and if he/she finds it, he/she marks it with a dauber or a chip. The element of skill in the game is the ability to search one's card for the called number in the shortest time before the next number is called. One of the most common patterns, called a “full card,” is grayed out and winning consists of marking all the numbers on the card. Other common card patterns are single line, two lines, the four corners, center cross, postage stamp (2×2 and in a corner), inner square (4×4), roving square (3×3), roving kite (a 3×3 diamond), etc. Lines can be made horizontally, vertically, or diagonally. Inner and roving squares and kites must be completely filled; roving squares and kites may be made anywhere on the card.

The caller continues to select and announce numbers until the first player forms the agreed pattern (which may be, for example, one line, two lines, or a “full house”) on his/her card and shouts out the name of the pattern or bingo.

There are about (5.52)(10)²⁶, (i.e., 155×145×135×125×114) possible arrangements of the numbers on a bingo card. A card can hold, at most, 19 chips or be marked with 19 daubs, not counting the free space. In order for this to happen, only one empty cell can reside in each row and each column, and at least one empty cell must be in each diagonal.

There are many variations of the basic bingo game which are well known. There is also: “pre-called bingo,” in which some or all of the numbers may be called in advance of the game and sealed to be opened during play; “progressive bingo,” in which to win, the player must obtain a predetermined combination in a specific number of calls. In case the winner is not decided in the number of calls specified, the prize money is carried over to the next round; “bonus bingo,” in which bingo is not compulsory but a bonus associated with other games. To play the bonus game, the player is usually required to pay an extra eligibility fee to win the bonus prize. The bonus game is usually won in a predetermined way so as to make a winning card statistically less likely and the money in the bonus pot is rolled over, the pot growing bigger with each round until it is won. Bingo may be played in halls, on TV, and/or on-line. The game has the advantage of providing communal participation because each game is played within a period of time and winners are selected from those playing.

(Alternatively, the game can be played as a game of pure chance with so-called “instant win” cards in which the bingo numbers are arranged in patterns which are covered over with a scratch off coating.)

Because the numbers on the bingo cards are limited, the mathematical odds of winning are relatively low to the total amounts wagered by all players. In recognition of these odds, the amount available for winners is likewise small.

Lotto (the term derived from “lottery”) is played throughout the world with many variations. Description of various lotto games are also well known. Typically, a player chooses numbers from a pay slip or bet slip which has a number of boxes on it. These boxes are called “boards.” For example, a player may select six numbers by marking them on a board. One may play any number of games at the same time by purchasing other boards. Also, as is well known, a computer is used to generate random numbers. If no one selects all of the numbers chosen in a game, the prize money is usually rolled over or increased by a predetermined amount for the next game.

Lotto usually awards extraordinarily large prizes but with very high odds against winning. Unlike bingo, the game is played by making the numerical selection and then waiting for the lotto entity to call the winning numbers. Lotto is a solitary game in which the player attempts to select the winning numbers from a predetermined set of numbers. Play is made against a computer that randomly selects the winning numbers. Play is usually solitary and over quickly. There is no communal playing as in bingo.

In keno, an enclosure contains 80 ping pong like balls. Each ball is imprinted with a number (usually 1 through 80, respectively). To draw a ball, a blower pushes air into the enclosure and mixes the balls. Similar devices are used in bingo and lotto. A “caller” presses a lever opening a tube connected to the enclosure. Air pressure pushes one ball into a receptacle. The caller and a “verifier” record each of the 20 balls drawn at random by the blower. The computerized keno system calculates all wagers based on the numbers drawn.

Players place their bets by marking an ‘X’ over their “spot” choices on a blank keno ticket form having 80 numbered selection boxes numbered 1 to 80. After all players place their wagers, the casino draws 20 balls at random.

Casinos set their own series of pay outs, usually referred to as “pay tables.” A winning player is paid based on how many numbers drawn match the numbers selected on the winning ticket and according to the pay table. There are many different forms of keno pay tables and they vary from casino to casino. There are large deviations in the house edge set for each of the pay tables. Additionally, each casino typically offers many different pay tables and specialty keno bets for customers to choose from. No two casinos' keno pay tables are identical. The general concept of keno is well known.

### SUMMARY

There is provided a method of playing a game of chance of the type played by a player, said method comprising the steps of:

providing a set of game matrices to each player, each matrix within a set being associated with a particular game in a series of games;

assigning a pari-mutual number sequence to each set of game matrices;

playing each game within the series of games;

allocating a respective number drawn during each game of the series to a respective position within a resulting pan-mutual number sequence;

comparing each assigned pari-mutual number sequence to the resulting pari-mutual number sequence; and

identifying at least one assigned pari-mutual number sequence that most closely matches the resulting pari-mutual number sequence.

The method may also include any of the following such as wherein the step of assigning is performed by generating random number sequences for each set of game matrices. The step of assigning is performed by selecting random numbers from a predetermined set of numbers. The step of inspecting authentication indicia printed on each of said set of game matrices to validate each set of game matrices. The series of games in the step of playing is performed in a predetermined order. The series of games in the step of playing is performed in an order determined by each player provided with a set of game matrices. The step of awarding a grand jackpot prize to the player provided with an assigned pari-mutual number sequence matching the resulting pan-mutual number sequence. The step of rolling over said grand jackpot prize to a next series of games when none of said assigned pari-mutual number sequences match the resulting pan-mutual number sequence. The step of awarding a consolation prize to a player if at least one number of said assigned pan-mutual number sequences matches at least one number of the resulting pari-mutual number sequences. The series of games in the step of playing is performed in successive order. The step of playing each game within the series further comprises the step of marking off a pattern on each of said game matrices.

There may be provided a game of chance of the type played by a plurality of players. The game comprises a plurality of sets of game matrices, each matrix within a set being associated with a predetermined game in a series of games, at least one of said plurality of sets of game matrices being provided to each player. There may be a plurality of pari-mutual number sequences, each sequence being assigned to a respective set of game matrices. There may also be means for randomly selecting indicia, the means for randomly selecting indicia drawing indicia during each of the series of the games, and a respective indicia drawn during each of the series of games are allocated so as to generate a resulting pari-mutual number sequence for comparison with each assigned pari-mutual number sequence.

Other features of the game apparatus may include where the plurality of sets of game matrices comprises respective verification indicia. Each column of a matrix within a set of game matrices is associated with a letter identifying the column. The letters are: B, I, N, G, and O. Each set of game matrices includes five matrices. Each matrix within a set of game matrices is associated with a pattern. The pattern is predetermined and determines the winner of an individual game. Each assigned pari-mutual number sequence is selected in advance by each player. The resulting pari-mutual number sequence is selected from a predetermined set of numbers at a predetermined point in each individual game. There is a jackpot which may be rolled over to a next set of games when none of the assigned pari-mutual number sequences match the resulting pari-mutual number sequence. There may be a bonus indicator, associated with a bonus number. The bonus indicator may indicate eligibility for winning a bonus prize, a bonus winner for a particular individual game being determined when the bonus indicator on a game card indicates eligibility for winning a bonus prize and a bonus number associated with the bonus indicator matches a final selected number for the particular individual game.

There may also be provided a game of chance of the type engaged in by players which comprises a plurality of sets of games. Each of the games within at least one of the sets is associated with at least one predetermined of the games in a series of the games, at least one of the plurality of sets of games being provided to each of the players of the game. A plurality of pari-mutual number sequences, each sequence being assigned to a respective predetermined set of the games. There are means for randomly selecting indicia, the means for randomly selecting indicia selecting a plurality of indicia during each of the games of the series of individual games, and a respective indicia drawn during each particular one of the games of said series of individual games being allocated so as to generate a resulting pari-mutual number sequence for comparison with each said assigned pari-mutual number sequence.

Other features of the game apparatus may also include each of the plurality of sets of games comprises respective verification indicia. Each column of a matrix within a set of game matrices is associated with a letter identifying the column. The letters are: B, I, N, G, and O.

Each set of game matrices includes five matrices. Each matrix within a set of game matrices is associated with a pattern. The pattern is predetermined and determines the winner of an individual game. Assigned pari-mutual number sequence is selected in advance by each player. The resulting pari-mutual number sequence is selected from a predetermined set of numbers at a predetermined point in each individual game. A jackpot may be rolled over to a next set of games when none of the assigned pari-mutual number sequences match the resulting pari-mutual number sequence. A bonus indicator, associated with a bonus number. The bonus indicator indicates eligibility for winning a bonus prize, a bonus winner for a particular individual game being determined when the bonus indicator on a game card indicates eligibility for winning a bonus prize and a bonus number associated with the bonus indicator matches a final selected number for the particular individual game.

There is a method for presenting a game of the type where players participate before an audience and the game is transmitted over a communication medium, the game being performed in a staged setting and the game presentation having a repetitive series of steps, comprising: (a) providing a set of games to each player of the game, each associated with a particular one of the games in a series of individual games; (b) assigning a pari-mutual number sequence to a each set of game matrices; (c) selecting a device for carrying a plurality of game identification indicia cassettes, each cassette being associated with a particular individual game; (d) unlocking a compartment for storing a plurality of cassettes; (e) loading a plurality of indicia bearing objects from the selected cassette into a device for randomly selecting the objects, each object having a predetermined indicia thereon to be drawn during a respective game within the series of individual games; (f) playing a game within the series of individual games; (g) allocating an indicia drawn during the game of the series to a respective position within a resulting pari-mutual number sequence; (h) repeating steps c)-g) with each cassette; (i) generating a resulting pari-mutual number sequence from the allocated numbers; (j) updating a display board for displaying game information, said game information including at least one of: the resulting pari-mutual number sequence, a most recently drawn game ball, a winning pattern of cells in a game matrix, and a bonus number; (k) comparing each assigned pan-mutual number sequence to the resulting pari-mutual number sequence; (l) identifying each player having the assigned pari-mutual number determined to most closely match the resulting pari-mutual number sequence as a winner; (m) displaying each player identified as a winner of the game on an elevated podium.

The method includes the following additional features in which the step of unlocking the compartment is performed simultaneously by a first person using a first key and a second person using a second key. The step of playing the game includes loading a plurality of indicia bearing objects in a bingo blower; and randomly selecting objects within the bingo blower individually. The step of assuring cassettes have not been tampered with by passing a loop of wire through apertures on a side and top wall of a cassette, and closing the cassette with a seal. The players pay a sum when provided with a set of games. The step of authorizing the beginning of a game by an auditor before playing a game.

A ball storage and selecting apparatus of the type used with indicia bearing objects such as bingo balls or the like which comprises a plurality of cassettes, each cassette receiving a respective at least a set of the indicia bearing objects. Each cassette comprises a plurality of compartments. Each compartment receives a subset of the respective game ball set, an integrated carrying mechanism. There is also provided at least one selectively-openable side wall; a top wall; and a blower. The blower had a blower chamber, a translucent chute, and a receiving tray. The at least one selectively openable side wall includes an aperture for receiving a locking mechanism providing selective access to the plurality of compartments. The top wall further comprises an aperture for receiving a locking mechanism; and a locking mechanism extendable through the aperture in the side wall and the aperture in the top wall secures the game ball set. The locking mechanism includes a wire, said wire forming a loop; and a tamper-evident seal for closing said wire. The receiving tray is dimensioned to receive each of the plurality of cassettes and conditioned to selectively open the side wall of the cassette. An opening the side wall causes the game balls in each compartment to roll through the translucent chute and into the blower chamber. The apparatus can also include a translucent storage vault which has a plurality of compartments, each compartment housing a respective one of the plurality of cassettes and having a selectively-openable door, and a plurality of locks, each lock being positioned on a respective compartment door for selectively securing the compartment door in a closed position. The blower further comprises a cowling for enclosing and masking cable connections. A display board for displaying indicia on a selected indicia bearing object. The cassettes are formed of a translucent, plastic material. The translucent, plastic material is Lexan.

### BRIEF DESCRIPTION OF THE DRAWINGS

In order that the device and method may be more fully understood, it will now be described, by way of example, with reference to the accompanying drawing in which:

FIG. 1 is a planar view of a ticket used in the game;

FIG. 2 is a perspective view of a television set used in the game;

FIG. 3 is a perspective view of the center of the set;

FIG. 4 is a perspective view of the bingo blower in the center section of the set;

FIG. 5 is a perspective view of the bingo vault of the game;

FIG. 6 is a perspective view of the game selection and winners' podium;

FIG. 7 is a schematic view of the display board;

FIG. 8 is a perspective view of the display screen and cowling used with the blower;

FIG. 9 is a side sectional view of the touch screen and cowling;

FIG. 10 is a perspective of a cassette used in the game;

FIG. 11 is a side view of the cassette of FIG. 10;

FIG. 12 is a perspective sectioned view of the cassette of FIG. 10;

FIG. 13 is a perspective sectioned view of one wall of the cassette of FIG. 10; and

FIG. 14 is an exploded, perspective, and sectioned view of the blower used in the game.

### DETAILED DESCRIPTION

The game described herein provides a series of individual games played in a predetermined order. The series of games may be set out on a single game card. As with any game of chance, players may purchase any number of game cards and play them simultaneously. Each game on a card may have numbers selected at random from a predetermined set of numbers arranged within subsets. A predetermined pattern filled out in each game determines the winner of that game. An exemplary model of the game described herein is bingo. However, any other type of game with similar characteristics may be used as well.

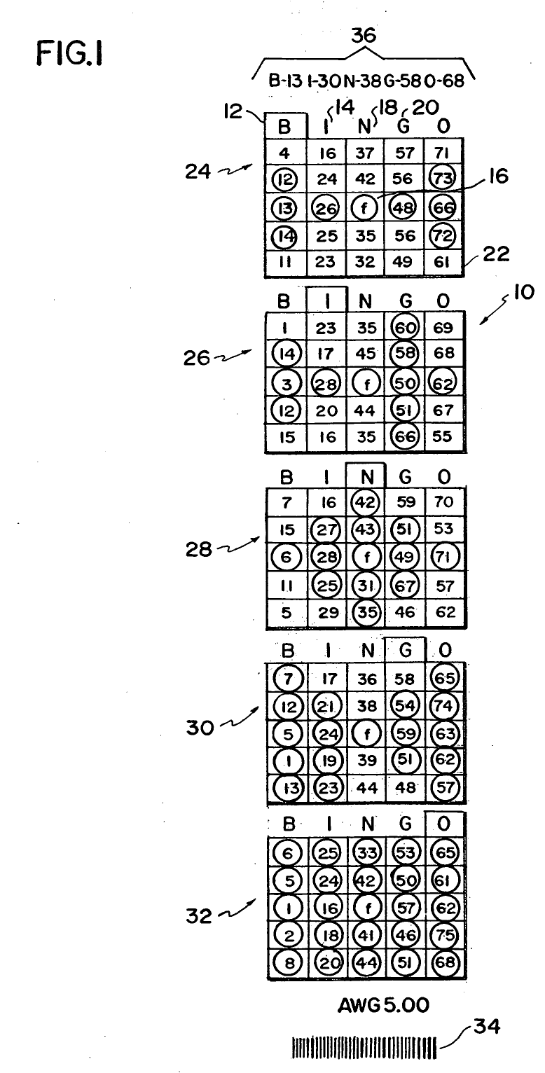

FIG. 1 shows a bingo card 10 that is used to play the game. Bingo card 10 includes at least one grid of five numbers in B column 12, five numbers in I column 14, free space 16, four numbers in N column 18, five numbers in G column 20, and five numbers in O column 22.

Bingo card 10 includes five discrete games, 24, 26, 28, 30, and 32. Each game on bingo card 10 may be played in any order, according to their identifying letter. For example, there may be ‘B’ game 24, ‘I’ game 26, ‘N’ game 28, ‘G’ game 30, and ‘O’ game 32. With multiple games on each card or ticket, a player has a chance to win one or more games. The integral pari-mutual play characteristics of the game are explained in further detail below. Bingo card 10 may further include authentication and verification indicia to allow a sponsor of the game to ensure that the game is properly conducted. On bingo card 10, this authentication and verification indicia is represented by bar code 34.

Numbers are then drawn or selected in each game until there is a bingo winner. A player may win one or more bingo games on bingo card 10. Players that are able to fill the pattern completely on bingo card 10 are awarded a guaranteed consolation prize. Consolation prizes are awarded for each successive bingo game, and increase in size with each additional bingo game won. Prizes won in bingo are considerably lower than prizes won when a player is able to match selected pari-mutual numbers with a winning set of pari-mutual numbers.

Each of a five game series, such as the one shown on bingo card 10, may be identified by a corresponding letter of the word “bingo.” Thus, there exists a ‘B’ game, an ‘I’ game, an ‘N’ game, a ‘G.’ game, and an ‘O’ game. At the end of the five successive games of bingo card 10, each discrete bingo game will have contributed one of the winning pari-mutual numbers to the complete set of winning pari-mutual numbers. To select the winning pari-mutual numbers, the first ‘B’ number called in the ‘B’ game may be the ‘B’ pari-mutual number, the first ‘I’ number called during the ‘I’ game may be the ‘I’ pari-mutual number, and so on. Pari-mutual numbers 36 are located at the top of bingo card 10 and may be predefined or selected in advance by the player. Pari-mutual numbers 36 may also be located at another location of bingo card 10 if desired. It is a matter of choice at which point in each game a drawn number from a designated subset shall be chosen to be a pari-mutual number.

Players that successfully match five numbers, one drawn from each bingo game, to the set of pan-mutual winning numbers are grand prize jackpot winners. If there is no five match winner, the jackpot may be rolled over to the next set of games (i.e., on the next card—not shown) to provide a progressively increasing jackpot. Players that match four, three, or two of the pari-mutual winning numbers may also be eligible for a prize as well.

A non-player, identified as a “draw-host” or “caller” may draw the numbers for the game played on bingo card 10. The numbers may be drawn randomly from a container or blower, and announced, displayed, or called out to players. Once a number is called, it is set aside, or retired, so that it cannot be chosen again. Players search their cards for the called number in the predetermined game currently in play, and if found, the number is marked on bingo card 10, usually with a dauber. The ‘B’ game is generally played first, and proceeds until there is a winner. The ‘I’ game, and succeeding games all proceed in a similar manner. The ‘O’ game is always called a full card, blackout, or cover-all, which means that all numbers must be marked in that particular game. Individual and successive games exist with drawings to select winning numbers for each game.

Prior to the commencement of a game session, which includes five bingo games, a player may purchase and/or option to win a progressive jackpot. An example of this may be illustrated by a first number drawn before the official start of a ‘B’ game. If a player wins a bingo game with the drawn number as the player's last number is called, the player wins a progressive jackpot.

A particular game is won when a player is able to correctly guess or predict the five pari-mutual numbers, one in each game, from the ‘B’ game, ‘I’ game, ‘N’ game, ‘G’ game, and ‘O’ game. As described, each individual game provides for the awarding of consolation prizes in order to maintain player interest in the ongoing pari-mutual game.

Unlike bingo, the current game illustrated by bingo card 10 allows for balls to be drawn for the dual purpose of winning the current bingo game in progress, and also to possibly contribute to one of the numbers of the winning pari-mutual set. As discussed, by correctly guessing or predicting all five numbers, one from each discrete game, a player is able to win the jackpot. Because the game is played until there is a winner for each of the bingo games, individual prizes are also awarded for each particular bingo game in the form of consolation prizes. The pari-mutual number pot, or grand prize may also be rolled over to a new game to build an increasing jackpot. As players move from one game card to the next, and assuming the pari-mutual jackpot has not been won, tension and excitement is allowed to build for the players and a prospective audience from game to game.

The game described herein may use sets of bingo-type balls, each with a coordinating number or other indicia, such as a letter. However, other means to display numbers or indicia may also be used, such as computer-generated and displayed numbers. A number may be called and then drawn at the specified time for the pari-mutual draw simultaneous to the number used in an ongoing bingo game. By combining the selected numbers from each game, the final five pari-mutual numbers are selected.

Players choose numbers in each predetermined subset, or game and mark off a pattern in each game. At the end, the pari-mutual winners are determined, if any exist. A player must select one number from each of the five subsets or games, and cannot select consecutive numbers. Once a bingo winner is chosen after five games, the game is stopped and a new set of bingo games begins.

The game described herein further utilizes an easy to understand payout structure. If the predetermined number of wins is matched, in this case five games, the progressive jackpot is won. If 4, 3, or 2 wins are matched, then lesser prizes are awarded. Winners of each game may also win a prize if they fill out the pattern of each game on bingo card 10.

The game may be played in public halls, on television, via the Internet, etc. In public performances, the game may be played in a staged setting.

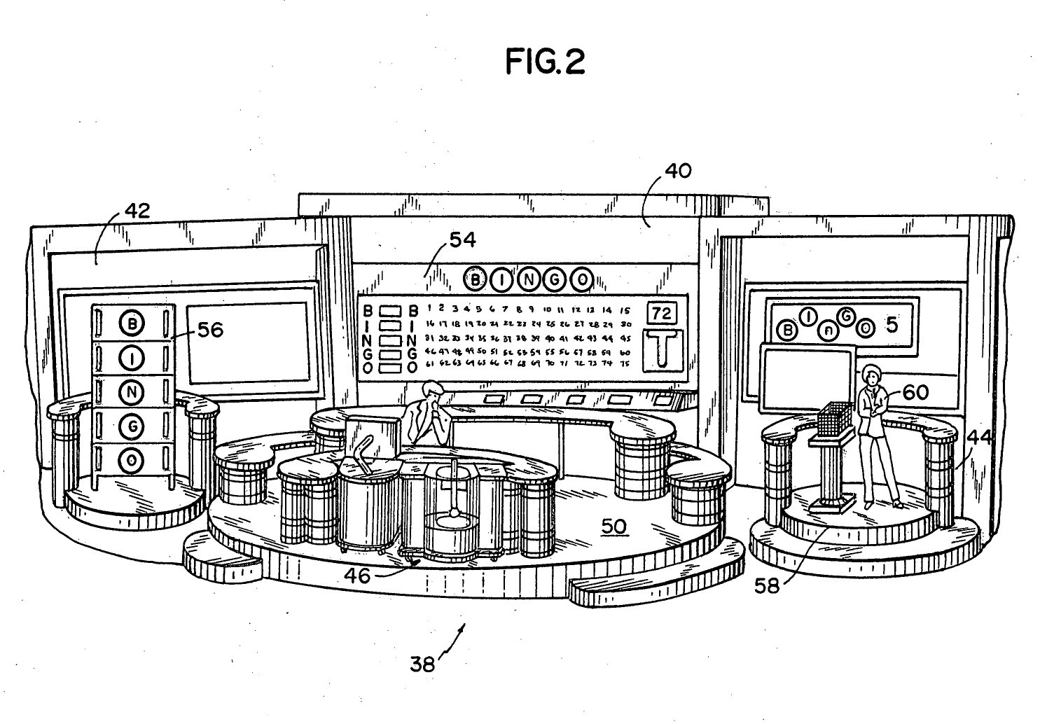

FIG. 2 shows the game set up in a staged setting for viewing in a public hall or for filming on television. Four sections 38, 40, 42, and 44, each with its own function, equipment, and procedures together comprise an operable and interrelated gaming system or apparatus. The purpose of using different sections to each represent a different aspect or function of the game is to lend transparency to the game to ensure that it is run honestly. Different stage themes may also be incorporated to associate the game with a theme that viewers have an affinity towards.

The first section 38 may serve as the location where numbers are drawn and may be located downstage center. The numbers may be drawn in any manner well known in the art. For example, bingo balls may be drawn by bingo blower 46. Bingo blower 46 is preferably centered on the set at a waist high position, directly in front of a camera. First section 38 may further include an elevated podium 50 from which a caller or host is located and calls out the numbers on the bingo balls. Podium 50 may be constructed of any well known material such as wood, plastic, metal, or any combination thereof.

The second section 40 may include a display board 54 for displaying called numbers. Display board 54 may be at center stage and up stage from podium 50. Display board 54 may also be elevated for easy viewing by an audience and cameras. Furthermore, display board 50 may be used to display the pattern of the current game and any additional numbers used in the game. Display board 54 may be made of any well known structural material and may further include incandescent lights, LED displays, and the like. Recess or accent lighting may be used to illuminate the second section in order to further highlight the numbers being drawn.

The third section 42 may be positioned stage left and used to store balls used in the game. A vault structure 56 with double locked transparent compartments in an armoire may house ball cassettes 112 and is described further below in correspondence to FIGS. 10-13. In this exemplary illustration, FIG. 2, five cassettes may be stored in vault structure 56, one for each lettered game (i.e., B, I, N, G, and O). In order to represent that the games are run honestly and without tampering, the cassettes 112 may be made of a translucent, plastic material, such as Lexan®.

The fourth section 44 may be positioned stage right and provides a stage for winners of the game or alternatively called a winner's circle. A winner 60 may stand in section 44 when a game is completed to await a host or assistant to award winner 60 an award.

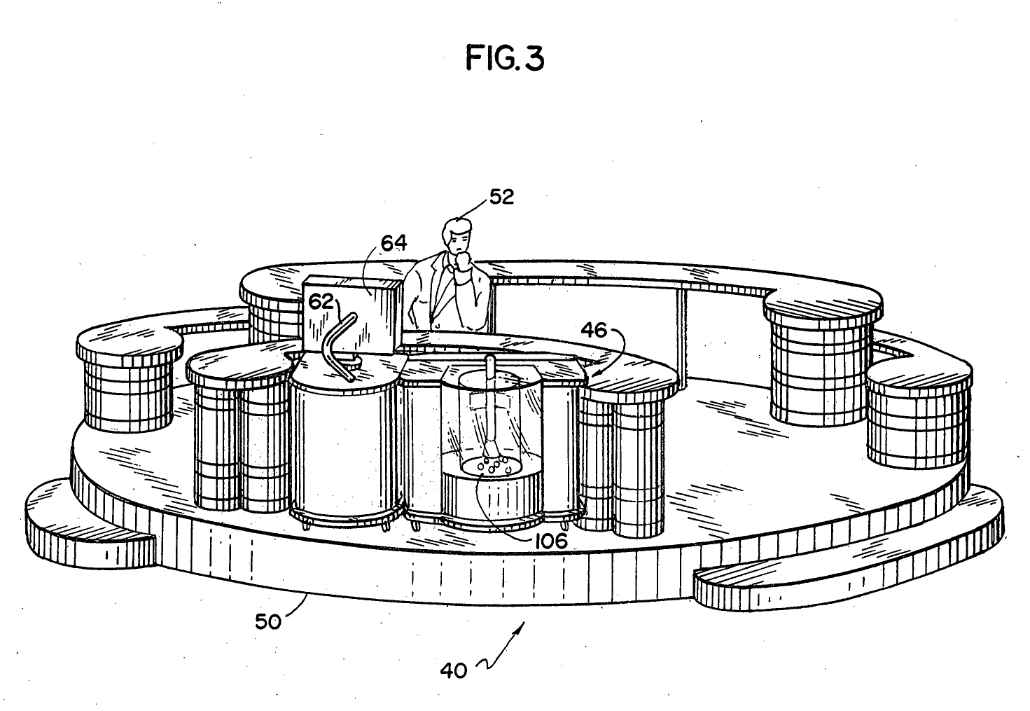

FIG. 3 displays an expanded perspective view of section 38 shown in FIG. 2. The primary objects found are a host's chair 52 and bingo blower 46.

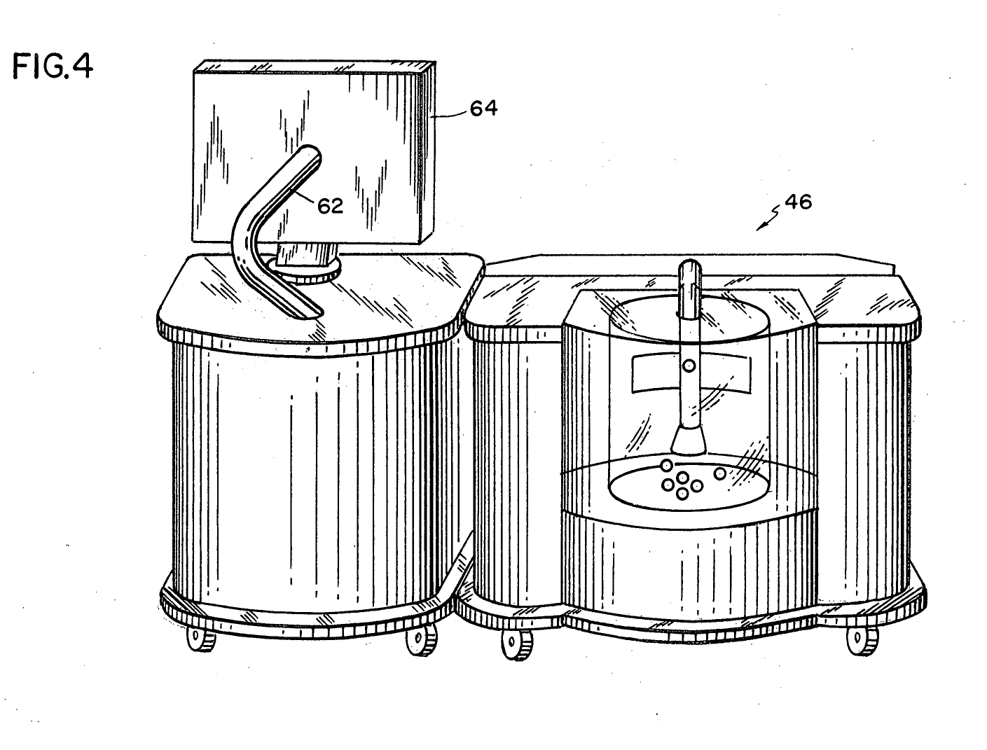

FIG. 4 displays an expanded view of bingo blower 46 as shown in FIG. 2. Bingo blower 46 may be any commercially available bingo ball blower console. Bingo blower 46 may include a cowling 62 to enclose cable connections from a CPU cabinet 66 to avoid a visual appearance of connection cables. In addition, a touch screen monitor housing 64 protects and displays a touch screen monitor.

FIG. 5 displays an expanded perspective view of vault structure 56 shown in FIG. 2. Vault structure 56 may be made of any convenient type of material intended to hold preassembled racks of bingo balls. In FIG. 5, vault structure 56 includes five compartments 66, 68, 70, 72, and 74. Vault structure 56 may further be defined by four upright legs 76, 78, 82, and 84, made of any well known structural material, such as aluminum. Five horizontal shelves 86, 78, 90, 92, and a top 94, further define vault structure 56. Five shelving units 96, 98, 100, 102, and 104 may be enclosed on all sides by vertical walls of any structural translucent material such as Lexan®. One side wall of each shelving unit 96, 98, 100, 102, and 104 may be a mounted on hinges with a pivotal door that allows access to the interior of vault structure 56. Each door may be double locked and require at least two keys to open the door. The sides of vault structure 56 may also be translucent to show those viewing the game that none of the sets of balls have been tampered with. A game usually begins once balls are loaded into vault structure 56.

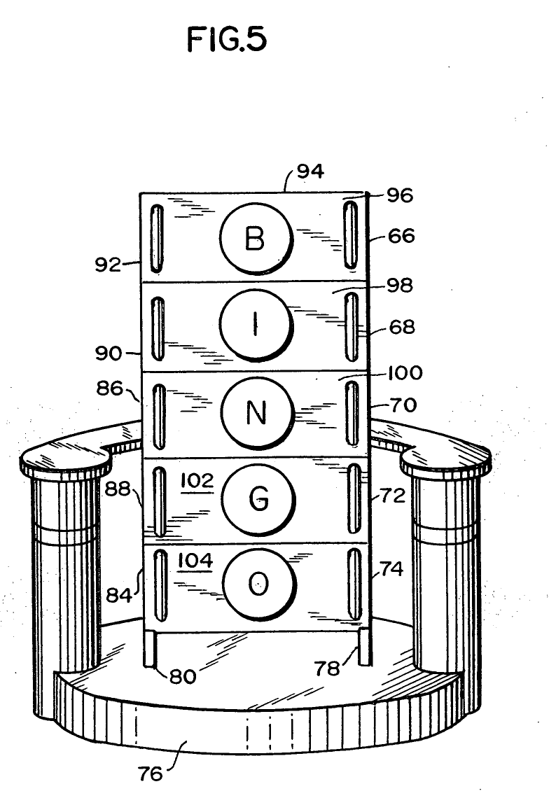

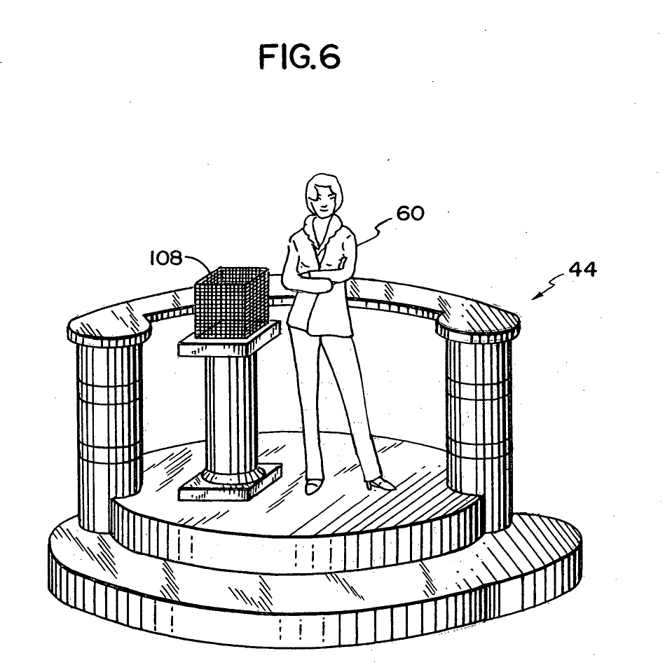

FIG. 6 displays an expanded perspective view of a winner's circle shown in FIG. 2. The winner's circle allows for the drawing of lettered balls and the payment of checks to winners. A pedestal and a bingo cage 108 are present in this area. A host may draw a lettered ball in order to select a case, which will be brought over to the bingo blower. At the end of a game, all winners may proceed to the winner's circle to collect their checks. A host and assistant may stand with the highest winner on the highest tier with other winners standing on the lower tier.

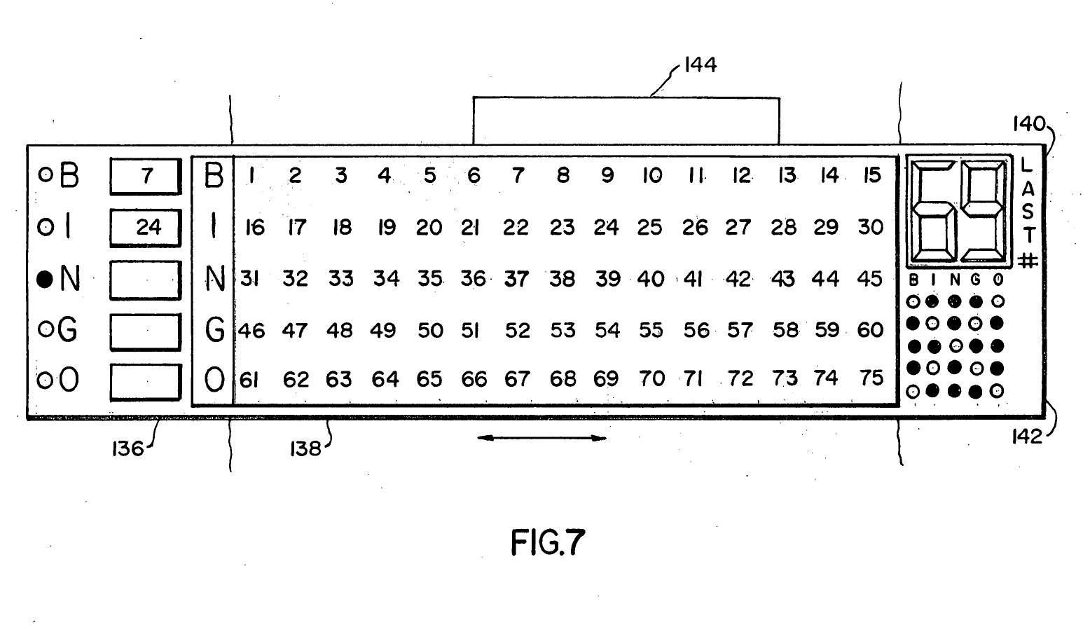

FIG. 7 shows a detailed view of the display board 54 shown in FIG. 2. Display board 54 may have five sections 136, 138, 140, 142, and 144 for displaying information about a particular game. The arrangement of each section 136, 138, 140, 142, and 144 is a matter of personal choice. In this exemplary model, first section 136 is used to display the numbers called for pari-mutual betting. Second section 138 is used to display the call of letters in each game. Third section 140 is used to display the last bingo number called. Fourth section 142 is used to display the pattern of the current game. Fifth section 142 displays a special number that is provided to players for an opportunity to win an extra prize.

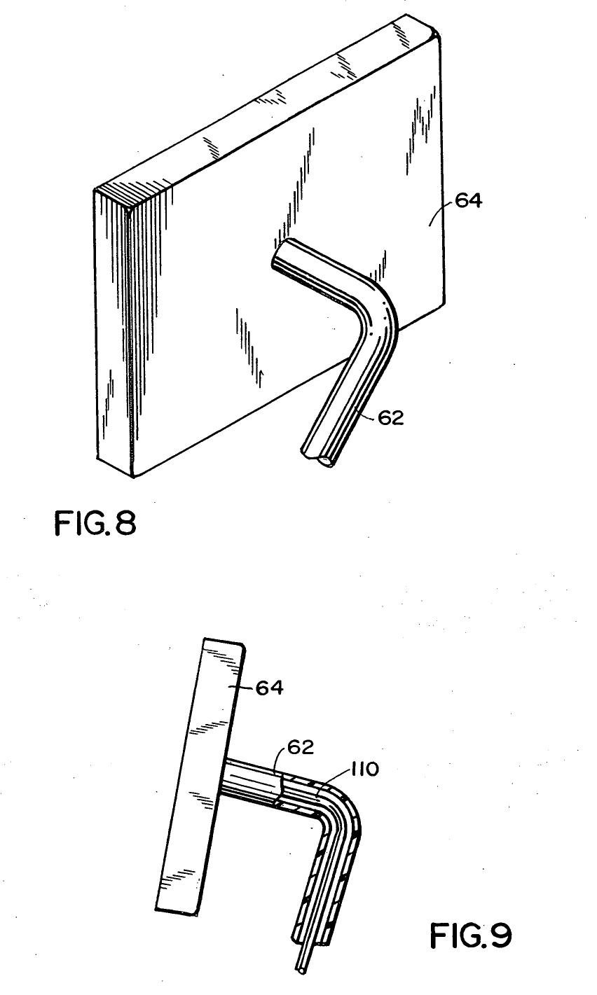

FIG. 8 displays a close up front perspective view of a cowling 62 and monitor housing 64 used on bingo blower 46 shown in FIG. 4. Cowling 62 and monitor housing 64 serve to block the visual appearance of cables so that an audience will not see cables.

FIG. 9 displays a side perspective view of cowling 62 and monitor housing 64. An interior view also shows cables 110 present within cowling 62. As illustrated, cowling 62 hides the visual appearance of cables 110 for aesthetic purposes.

FIG. 10 shows a side perspective view of a cassette used for loading into vault structure 56. A cassette 112 has a series of compartments for housing bingo balls. A handle 118 is secured to the top wall 120 of cassette 112. Handle 118 may be made of plastic or metal, and secured to top wall 120 by any well known means, such as bolts or adhesives, and positioned to permit convenient carrying of cassette 112 to vault structure 56. One side wall 122 of cassette 112 may be slidably mounted to cassette 112.

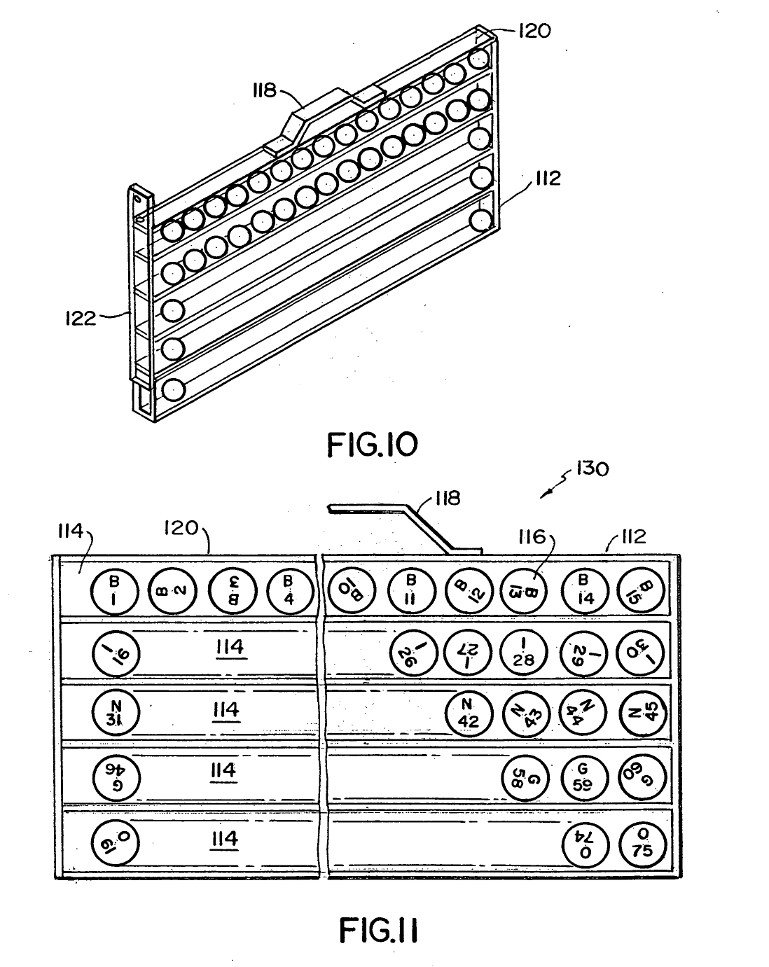

FIG. 11 shows a front view of a cassette used for loading into vault structure 56. Five compartments 114 are shown for receiving bingo balls 116. A particular set of bingo balls is loaded into a compartment corresponding to a particular letter subset, such as B, I, N, G, and O.

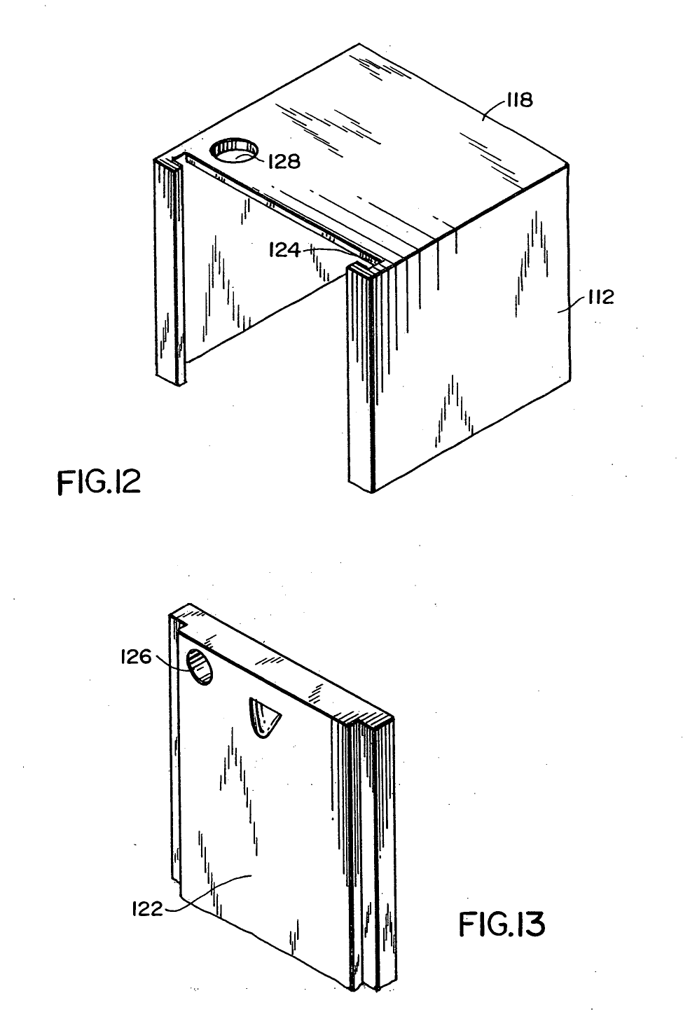

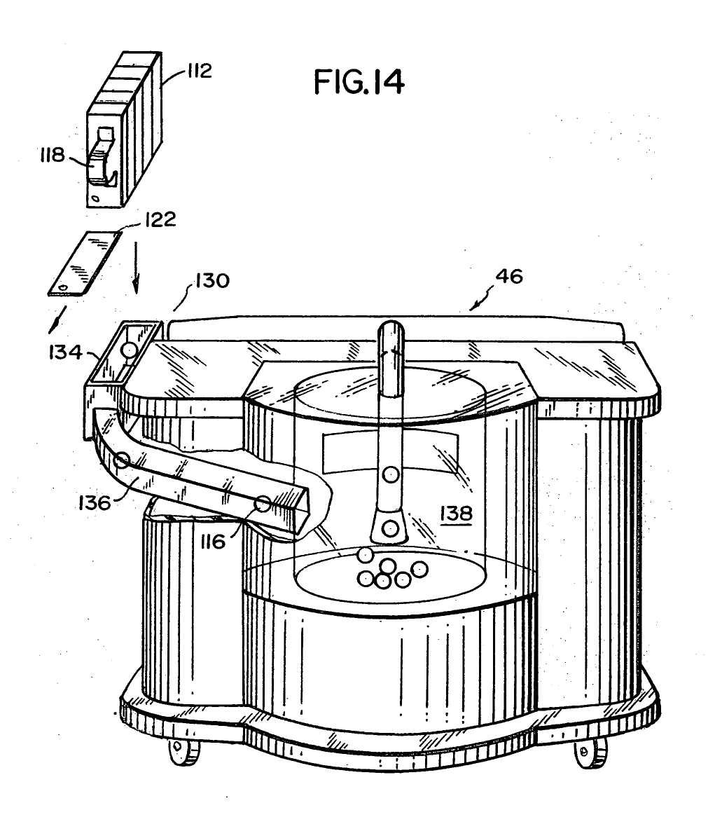

FIG. 12 shows a close up perspective view of cassette 112 and in particular, slidable side wall 122. Side wall 122 is slidably mounted to cassette 112 by a tongue or groove slide 124. Removing side wall 122 from cassette 112 gives access to the five compartments 114. When setting up a game, each of five cassettes is loaded with balls 116 and then the cassettes are loaded into vault structure 56. To ensure that cassettes have not been tampered with, each particular cassette 112 may have an aperture 128. Once balls are loaded into cassette 112, and side wall 122 is closed, a loop of wire may be passed through aperture 128 on top wall 118. FIG. 13 shows a close up perspective view of the side of cassette 112. Slide wall 122 of cassette 112 may have an aperture 126 for passing a loop of wire through. This loop of wire passes through aperture 128 on top wall 118 through aperture 126 on side wall 122. A seal may then be affixed to the apertures to further ensure cassette 112 has not been tampered with.

FIG. 14 shows a detailed view of bingo blower 46. As a game proceeds, a host and auditor both use a key to open a compartment designated by an unnumbered and lettered bingo ball drawn from section 44 depicted in FIG. 2. A selected cassette is then taken to bingo blower 46. Housing 130 is designed with a receiving tray 134 dimensioned to receive a cassette in a substantially horizontal orientation and spaced from the bottom wall of receiving tray 134 so that when a wall of the cassette is removed, balls are free to roll out one compartment of the cassette at a time. Attached to receiving tray 134 is an enclosed chute 136 which may be made of a translucent material such as Lexan®. The balls roll down chute 136 and into blower chamber 138. Once the balls are in blower chamber 138, bingo blower 46 performs like all known blowers, dispensing balls one at a time. Receiving tray 134 is dimensioned so that upon inserting a cassette, the cassette is spaced above the lower wall and the cassette's sidewall may be removed through a slot in receiving tray 134.

The game officially begins when bingo game cards have stopped selling and an auditor has called a government representative to authorize the beginning of the drawing of bingo balls. A bingo ball case is selected for loading into a vault structure. Each successive bingo game is played, with each game providing a pari-mutual number. The winning bingo numbers are compared to numbers selected by players. Winners are then announced.

In another embodiment of the game, a player may purchase a number by paying a small sum. For ease of reference, but without limitation, the purchased number will be referred to as the “Bingo Star” and the games as “Bingo 5.” For example, one dollar may purchase a number, and the dollar will cumulatively fund a prize that is based upon the selected number. As a Bingo 5 game proceeds, if a player wins any game (e.g., the ‘B,’ ‘I,’ ‘N,’ ‘G,’ and/or ‘O’ games) with the Bingo Star as the last number called, the player wins the Bingo Star jackpot. A player does not have to select a special number. Rather, the player buys the option.

The playing of five games on a game card, is referred to as “Regular Bingo 5,” but without any intended limitation. As indicated above, players match five pari-mutual numbers to pari-mutual numbers selected during the games to win a progressive jackpot. Also, as previously described, a player's selected numbers are from each of a subgroup, such as B, I, N, G, and O. The game may be played with or without a Bingo Star number. In Regular Bingo 5, the Bingo Star may be indicated by an icon. Winners of each discrete Bingo 5 game are awarded consolation prizes.

In a different embodiment of the game, referred to as “Mega Bingo 5,” but without intended limitation, players must match the five pari-mutual numbers and a Mega Bingo Star. This increases the odds for a winner since it may be played in a larger population.

Another variation of Bingo star is called “Mega Bingo Star” which permits a player to pick a number from 1-75. This game is used in conjunction with Mega Bingo 5.

The odds for the games described above are presented below:

Regular Bingo 5 Series

| B | I | N | G | O |
|---|---|---|---|---|
| 1/15 × | 1/15 × | 1/15 × | 1/15 × | 1/15 |

| | Number | Odds | |
|---|---|---|---|
| Match 5 | 1 | 759375.00 | |
| Match 4 | 70 | 10848.21 | |
| Match 3 | 1960 | 387.44 | |
| Match 2 | 27440 | 27.67 | |
| Match 1 | 192080 | 3.95 | |
| Match 0 | 537824 | 1.41 | and so on. |

Winners of the Bingo 5 games receive consolation prizes.
Mega Bingo 5 combines the regular Bingo 5 odds with 1/75

Mega Bingo Star

| B | I | N | G | O |
|---|---|---|---|---|
| 1/75 × | 1/15 × | 1/15 × | 1/15 × | 1/15 |

| | Number | Odds |
|---|---|---|
| Match 5 + Mega Bingo Star | 1 | 56953125 |
| Match 5 | 1 | 759375 |
| Match 4 + Mega Bingo Star | | |
| Match 4 | | |
| and so on. | | |

Bingo game winners receive consolation prizes as indicated above.

The game also need not be limited to being played with an audience. The same principles for playing the game may be applied to smaller groups for gaming at home, via computer software, or via the Internet.

What is claimed is:

1. A method of playing a game of chance of the type played by a player, said method comprising the steps of:
providing a set of game matrices to each player, each matrix within a set being associated with a particular game in a series of games;
assigning a pari-mutual number sequence to each set of game matrices;
playing each game within the series of games;
allocating a respective number drawn during each game of the series to a respective position within a resulting pan-mutual number sequence;
comparing each assigned pari-mutual number sequence to the resulting pan-mutual number sequence; and
identifying at least one assigned pari-mutual number sequence that most closely matches the resulting pari-mutual number sequence.

2. The method according to claim 1, wherein the step of assigning is performed by generating random number sequences for each set of game matrices.

3. The method according to claim 1, wherein the step of assigning is performed by selecting random numbers from a predetermined set of numbers.

4. The method according to claim 1, further comprising the step of inspecting authentication indicia printed on each of said set of game matrices to validate each set of game matrices.

5. The method according to claim 1, wherein the series of games in the step of playing is performed in a predetermined order.

6. The method according to claim 1, wherein the series of games in the step of playing is performed in an order determined by each player provided with a set of game matrices.

7. The method according to claim 1, further comprising the step of awarding a grand jackpot prize to the player provided with an assigned pari-mutual number sequence matching the resulting pari-mutual number sequence.

8. The method according to claim 7, further comprising the step of rolling over said grand jackpot prize to a next series of games when none of said assigned pari-mutual number sequences match the resulting pari-mutual number sequence.

9. The method according to claim 8, further comprising the step of awarding a consolation prize to a player if at least one number of said assigned pan-mutual number sequences matches at least one number of the resulting pari-mutual number sequences.

10. A method according to claim 1, wherein the series of games in the step of playing is performed in successive order.

11. The method according to claim 1, wherein the step of playing each game within the series further comprises the step of marking off a pattern on each of said game matrices.

12. A game of chance of the type played by a plurality of players, comprising:
a plurality of sets of game matrices, each matrix within a set being associated with a predetermined game in a series of games, at least one of said plurality of sets of game matrices being provided to each player;
a plurality of pan-mutual number sequences, each sequence being assigned to a respective set of game matrices; and
means for randomly selecting indicia, said means for randomly selecting indicia drawing indicia during each of said series of said games, and a respective indicia drawn during each of said series of games being allocated so as to generate a resulting pari-mutual number sequence for comparison with each assigned pan-mutual number sequence.

13. The apparatus of claim 12, wherein each of said plurality of sets of game matrices comprises respective verification indicia.

14. The apparatus of claim 12, wherein each column of a matrix within a set of game matrices is associated with a letter identifying the column.

15. The apparatus of claim 14, wherein said letters are: B, I, N, G, and O.

16. The apparatus of claim 15, wherein each set of game matrices includes five matrices.

17. The apparatus of claim 12, wherein each matrix within a set of game matrices is associated with a pattern.

18. The apparatus of claim 17, wherein said pattern is predetermined and determines the winner of an individual game.

19. The apparatus of claim 12, wherein each assigned pari-mutual number sequence is selected in advance by each player.

20. The apparatus of claim 12, wherein the resulting pari-mutual number sequence is selected from a predetermined set of numbers at a predetermined point in each individual game.

21. The apparatus of claim 12, wherein a jackpot may be rolled over to a next set of games when none of the assigned pari-mutual number sequences match the resulting pari-mutual number sequence.

22. The apparatus of claim 12, further comprising a bonus indicator, associated with a bonus number.

23. The apparatus of claim 22, wherein said bonus indicator indicates eligibility for winning a bonus prize, a bonus winner for a particular individual game being determined when said bonus indicator on a game card indicates eligibility for winning a bonus prize and a bonus number associated with said bonus indicator matches a final selected number for the particular individual game.

24. A game of chance of the type engaged in by players, comprising:
a plurality of sets of games, each of said games within at least one of said sets being associated with at least one predetermined of said games in a series of said games, at least one of said plurality of sets of games being provided to each of the players of the game;
a plurality of pari-mutual number sequences, each sequence being assigned to a respective predetermined set of said games; and
means for randomly selecting indicia, said means for randomly selecting indicia selecting a plurality of indicia during each of said games of said series of individual games, and a respective indicia drawn during each particular one of said games of said series of individual games being allocated so as to generate a resulting pari-mutual number sequence for comparison with each said assigned pari-mutual number sequence.

25. The apparatus of claim 24, wherein each of said plurality of sets of games comprises respective verification indicia.

26. The apparatus of claim 24, wherein each column of a matrix within a set of game matrices is associated with a letter identifying the column.

27. The apparatus of claim 26, wherein said letters are: B, I, N, G, and O.

28. The apparatus of claim 27, wherein each set of game matrices includes five matrices.

29. The apparatus of claim 24, wherein each matrix within a set of game matrices is associated with a pattern.

30. The apparatus of claim 29, wherein said pattern is predetermined and determines the winner of an individual game.

31. The apparatus of claim 24, wherein each assigned pari-mutual number sequence is selected in advance by each player.

32. The apparatus of claim 24, wherein he resulting pari-mutual number sequence is selected from a predetermined set of numbers at a predetermined point in each individual game.

33. The apparatus of claim 24, wherein a jackpot may be rolled over to a next set of games when none of the assigned pari-mutual number sequences match the resulting pan-mutual number sequence.

34. The apparatus of claim 24, further comprising a bonus indicator, associated with a bonus number.

35. The apparatus of claim 34, wherein said bonus indicator indicates eligibility for winning a bonus prize, a bonus winner for a particular individual game being determined when said bonus indicator on a game card indicates eligibility for winning a bonus prize and a bonus number associated with said bonus indicator matches a final selected number for the particular individual game.

36. A method for presenting a game of the type where players participate before an audience and the game is transmitted over a communication medium, the game being performed in a staged setting and the game presentation having a repetitive series of steps, comprising:
a) providing a set of games to each player of the game, each associated with a particular one of the games in a series of individual games;
b) assigning a pari-mutual number sequence to a each set of game matrices;
c) selecting a device for carrying a plurality of game identification indicia cassettes, each cassette being associated with a particular individual game;
d) unlocking a compartment for storing a plurality of cassettes;
e) loading a plurality of indicia bearing objects from the selected cassette into a device for randomly selecting the objects, each object having a predetermined indicia thereon to be drawn during a respective game within the series of individual games;
f) playing a game within the series of individual games;
g) allocating an indicia drawn during the game of the series to a respective position within a resulting pari-mutual number sequence;
h) repeating steps c)-g) with each cassette;
i) generating a resulting pari-mutual number sequence from the allocated numbers;
j) updating a display board for displaying game information, said game information including at least one of: the resulting pari-mutual number sequence, a most recently drawn game ball, a winning pattern of cells in a game matrix, and a bonus number;
k) comparing each assigned pari-mutual number sequence to the resulting pari-mutual number sequence;
l) identifying each player having the assigned pari-mutual number determined to most closely match the resulting pari-mutual number sequence as a winner;
m) displaying each player identified as a winner of the game on an elevated podium.

37. The method according to claim 36, wherein the step of unlocking the compartment is performed simultaneously by a first person using a first key and a second person using a second key.

38. The method according to claim 36, wherein the step of playing the game includes loading a plurality of indicia bearing objects in a bingo blower; and randomly selecting objects within the bingo blower individually.

39. The method according to claim 36, further comprising the step of assuring cassettes have not been tampered with by passing a loop of wire through apertures on a side and top wall of a cassette, and closing the cassette with a seal.

40. The method according to claim 36, wherein players pay a sum when provided with a set of games.

41. The method according to claim 36, further comprising the step of authorizing the beginning of a game by an auditor before playing a game.

42. A ball storage and selecting apparatus of the type used with indicia bearing objects such as bingo balls or the like, comprising:
a plurality of cassettes, each cassette receiving a respective at least a set of the indicia bearing objects, each cassette comprising:
a plurality of compartments, each compartment receiving a subset of the respective game ball set,
an integrated carrying mechanism,
at least one selectively-openable side wall;
a top wall; and
a blower having:
a blower chamber,
a translucent chute, and
a receiving tray.

43. The apparatus of claim 42, wherein said at least one selectively openable side wall includes an aperture for receiving a locking mechanism providing selective access to the plurality of compartments; said top wall further comprises an aperture for receiving a locking mechanism; and a locking mechanism extendable through the aperture in said side wall and the aperture in said top wall for securing said game ball set.

44. The apparatus of claim 43, wherein said locking mechanism includes a wire, said wire forming a loop; and a tamper-evident seal for closing said wire.

45. The apparatus of claim 42 wherein
said receiving tray is dimensioned to receive each of the plurality of cassettes and conditioned to selectively open the side wall of the cassette,
wherein opening the side wall causes the game balls in each compartment to roll through the translucent chute and into the blower chamber.

46. The apparatus of claim 42, wherein the apparatus further comprises:
a translucent storage vault having:
a plurality of compartments, each compartment housing a respective one of the plurality of cassettes and having a selectively-openable door, and
a plurality of locks, each lock being positioned on a respective compartment door for selectively securing the compartment door in a closed position.

47. The apparatus of claim 42, wherein said blower further comprises a cowling for enclosing and masking cable connections.

48. The apparatus of claim 42, further comprising a display board for displaying indicia on a selected indicia bearing object.

49. The apparatus of claim 42, wherein said cassettes are formed of a translucent, plastic material.

50. The apparatus of claim 48, wherein the translucent, plastic material is Lexan.
